(19) United States
(12) Patent Application Publication
(10) Pub. No.: US 2004/0024494 A1
(43) Pub. Date: Feb. 5, 2004

(54) On-line control of distributed resources with different dispatching levels

(76) Inventors: Deia Salah-Eldin Bayoumi, Fuquay Varina, NC (US); Danny E. Julian, Willow Spring, NC (US); Edward M. Petrie, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/040,998

(22) Filed: Dec. 28, 2001

(51) Int. Cl. G05D 11/00

(52) U.S. Cl. 700/286

(57) ABSTRACT

Dispatching schemes for distributed resources involve decisions made both at a central location and at the local level with respect to a distributed resource. To handle cases in which a decision made at the central location and a decision made at the local level conflict, a set of rules preferably determines the priority of control. A distributed resource preferably has an intelligent component associated with it. The intelligent component associated with the distributed resource is preferably pre-programmed with one or more dispatching scenarios. Distributed resources include demand and supply side resources that can be deployed within a distribution and sub-transmission system. Demand side resources include demand side or load management or energy efficiency options while supply side resources include generation sources, including photovoltaics, reciprocating engines, micro turbines, fuel cells, etc.

### FIELD OF THE INVENTION

The present invention relates in general to electrical power systems and, more particularly, to the management of distributed power resource systems existing in electrical power systems.

### BACKGROUND OF THE INVENTION

Traditionally, electrical power has been produced by large centralized power stations that generate electricity and transmit the electricity over high-voltage transmission lines. The voltage is then stepped-down in several stages and distributed to the customer. Electrical power distribution systems have been evolving due to drawbacks in the generation of power by large centralized power stations, due to changes in the regulation of the electrical industry, and due to technological advances in the development of different types of small power generators and storage devices.

The bulk of today's electric power comes from central power plants, most of which use large, fossil-fired combination or nuclear boilers to produce steam that drives steam turbine generators. There are numerous disadvantages to these traditional power plants.

Most of these plants have outputs of more than 100 megawatts (MW), making them not only physically large but also complex in terms of the facilities they require. Site selection and procurement are often a real challenge because of this. Often no sites are available in the area in which the plant is needed, or ordinances are in effect (such as no high voltage power lines are permitted in certain areas) that make acquisition of an appropriate site difficult.

There is considerable public resistance on aesthetic, health and safety grounds, to building more large centralized power plants, especially nuclear and traditional fossil-fueled plants. High voltage transmission lines are very unpopular. People object to the building of large power plants on environmental grounds as well. Long distance electricity transmission via high voltage power lines has considerable environmental impact.

Long distance transmission of electricity is expensive, representing a major cost to the end-user because of investment required in the infrastructure and because losses accrue in the long distance transmission of electricity proportionate to the distance traveled so that additional electricity must be generated over that needed to handle the power needs of the area.

Plant efficiency of older, existing large power plants is low. The plant efficiency of large central generation units can be in the 28-35% range, depending on the age of the plant. This means that the plant converts only between 28-35% of the energy in their fuel into useful electric power. To exacerbate the matter, typical large central plants must be over-designed to allow for future capacity, and consequently these large central plants run for most of their life in a very inefficient manner.

In areas where demand has expanded beyond the capacity of large power plants, upgrading of existing power plants may be required if the plant is to provide the needed additional power. This is often an expensive and inefficient process.

Some areas are too remote to receive electricity from existing transmission lines, requiring extension of existing transmission lines, resulting in a corresponding increased cost for electric power.

In part due to concerns regarding centralized power production, the enactment of the Public Utility Regulatory Policies Act of 1978 (PURPA) encouraged the commercial use of decentralized, small-scale power production. PURPA's primary objective was to encourage improvements in energy efficiency through the expanded use of cogeneration and by creating a market for electricity produced from unconventional sources. The 1992 Federal Energy Policy Act served to enhance competition in the electric energy sector by providing open access to the Unites States' electricity transmission network, called the “grid.”

Distributed power generation and storage could provide an alternative to the way utilities and consumers supply electricity which would enable electricity providers to minimize investment, improve reliability and efficiency, and lower costs. Distributed resources can enable the placement of energy generation and storage as close to the point of consumption as possible, with increased conversion efficiency and decreased environmental impact. Small plants can be installed quickly and built close to where the electric demand is greatest. In many cases, no additional transmission lines are needed. A distributed generation unit does not carry a high transmission and distribution cost burden because it can be sited close to where electricity is used, resulting in savings to the end-user.

New technologies concerning small-scale power generators and storage units also have been a force contributing to an impetus for change in the electrical power industry. A market for distributed power generation is developing. The Distributed Power Coalition of America estimates that small-scale projects could capture twenty percent of new generating capacity (e.g., 35 gigawatts) in the next twenty years.

Distributed generation is any small-scale power generation technology that provides electric power at a site closer to customers than central station generation. The small-scale power generators may be interconnected to the distribution system (the grid) or may be connected directly to a customer's facilities. Technologies include gas turbines, photovoltaics, wind turbines, engine generators and fuel cells. These small (5 to 1,500 kilowatt) generators are now at the early commercial or field prototype stage. In addition to distributed generation, distributed resources include distributed storage systems such as the storage of energy by small-scale energy storage devices including batteries, super-conducting magnetic energy storage (SMES), and flywheels.

Efficiency of power production of the new small generators is far better than traditional existing power plants. In contrast to the 28-35% efficiency rate of older, centralized large power plants, efficiencies of 40-50% are attributed to small fuel cells and to various new gas turbines and combined cycle units suitable for distributed generation applications. For certain novel technologies, such as a fuel cell/gas turbine hybrid, electrical efficiencies of about 70% are claimed. Cogeneration, providing both electricity and heat or cooling at the same time, improves the overall efficiency of the installation even further, up to 90%.

Project sponsors benefit by being able to use electric power generated by distributed resources to avoid high demand charges during peak periods and gain opportunities to profit from selling excess power to the grid. Utilities gain reliability benefits from the additional capacity generated by the distributed resources, and end-users are not burdened with the capital costs of additional generation. In some cases, electricity generated by distributed resources is less costly than electricity from a large centralized power plant.

Distributed generation and storage has been accompanied, however, by distributed management. The value of these new technologies could be greatly increased if it were possible to control multiple distributed resources from a central controller, or control each of a plurality of distributed resources individually, or a combination thereof.

### SUMMARY OF THE INVENTION

The present invention is directed to a dispatching scheme for distributed resources. Decisions, in one embodiment of the invention, are made at a central location (referred to herein as “central control”) and are transmitted to one or more distributed resources by a communications network.

Alternatively, decisions may be made locally (referred to herein as “local control”). In such an embodiment, a distributed resource preferably has an intelligent component associated with it. The intelligent component associated with the distributed resource is preferably pre-programmed with one or more dispatching scenarios.

Alternately, in still another embodiment of the invention (referred to herein as “hybrid control”), decisions are made both at a central location and at the local level. To handle cases in which a decision made at the central location and a decision made at the local level conflict, a set of rules preferably determines the priority of control.

According to embodiments of the invention, when a local scheme is in operation, continuous communication with the distributed device is unnecessary.

According to aspects of the invention, the dispatching scheme and level may be adjusted by a central location that communicates with the local intelligent device through the communications network.

Distributed resources include demand and supply side resources that can be deployed within the distribution and sub-transmission system. Demand side resources include demand side or load management or energy efficiency options while supply side resources include generation sources, including photovoltaics, reciprocating engines, micro turbines, fuel cells, etc. These resources may be installed either on the customer side or the utility side of the meter.

The foregoing and other aspects of the present invention will become apparent from the following detailed description of the invention when considered in conjunction with the accompanying drawings.

### BRIEF DESCRIPTION OF THE DRAWINGS

FIG. 1 is a block diagram of a distributed power generation system, as is known in the art;

FIG. 2 is a block diagram of an embodiment of a locally controlled distributed power resource management system in accordance with the invention;

FIG. 3 is a block diagram of another embodiment of a locally controlled distributed power resource management system in accordance with the invention;

FIG. 4 is a block diagram of an exemplary centrally controlled distributed power resource management system in accordance with the invention;

FIG. 5 is a block diagram of an exemplary hybrid centrally/locally controlled distributed power resource management system in accordance with the invention;

FIG. 6 illustrates an exemplary computing system in accordance with the invention; and

FIG. 7 illustrates an exemplary network environment in accordance with the invention.

### DESCRIPTION OF EXEMPLARY EMBODIMENTS AND BEST MODE

The disclosed invention is directed to providing a control system which can manage and control a plurality of distributed resources based on predetermined criteria, such as economic and engineering criteria. The control system can either be centralized or local to each distributed resource or may be a hybrid of centralized and local control.

More particularly, the present invention is directed to a dispatching scheme for distributed resources (DR). Decisions concerning whether the distributed resource(s) should be operated, and if so, at what level of capacity, may be made at a central location and may be transmitted to a distributed resource device through a communication infrastructure. These decisions could also be made locally at each distributed resource device. If decisions are made at a local level, an intelligent device pre-programmed with different dispatching scenarios preferably is associated with each distributed resource. If decisions are made primarily at a central level, no intelligent device may be associated with the distributed resource. The dispatching schemes and levels may be adjusted or changed by a central controller that communicates with the local intelligent devices through the communication infrastructure.

When decisions are made both at the central and at the local level, a set of rules and constraints preferably determines the priority of the control schemes. For example, if the local control determines the distributed resource should be turned on and the central control determines the distributed resource should remain off, either the decision made at the local control or the decision made at the central control will be acted upon. In accordance with one aspect of the invention, a set of rules determines which controller takes precedence. The rules may specify that either the local controller takes precedence or that the central controller takes precedence. Alternatively, the rules may specify under what conditions the decisions of the central controller take precedence and under what conditions the decisions of the local controller take precedence.

Dispatching the distributed resources existing in the electrical power system preferably is based on several economic as well as engineering decisions. The decisions are made by applications including but not limited to peak shaving, voltage profile dispatch, reliability dispatch, thermal dispatch, site load following dispatch, local area dispatch, and resource scheduling. Decisions preferably include whether or not a given distributed resource should be operated and at what dispatch level the unit should be operated. The dispatch level (i.e., at what level of capacity the distributed resource will be operated) is used in achieving an optimal mix and use of distributed resources, because, for example, a particular distributed resource may be more efficient (e.g., 45% efficient) when the resource runs at 50% capacity and less efficient (e.g., only 40% efficient) when the resource runs at 60% capacity. Hence to achieve optimal usage, it may be preferable to operate two distributed resource devices at lower than maximum capacity rather than one DR device at full capacity.

Distributed resources preferably may be turned on and off responsive to certain events. For example, distributed resources may be turned on when there is a regional power disruption, or when the price of power exceeds some threshold. A combination of applications including, but not limited to, peak shaving dispatch, voltage profile dispatch, reliability dispatch, thermal site load following dispatch, local area dispatch, and resource scheduling preferably are employed to determine whether to use a distributed resource or to use an alternate source of electrical power (e.g., the utility grid). Integration of the different applications in a modular scheme preferably provides flexibility in updating or changing any of the features of the system and enables coordination, integration, and optimization of usage of one or a plurality of distributed resource assets.

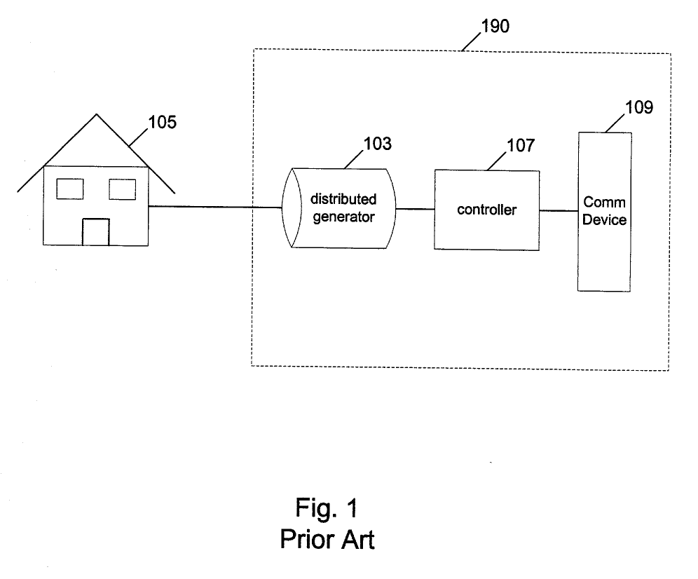

As can be seen from FIG. 1, distributed generation is any small-scale power generation technology such as a distributed resource 103 that provides electric power at a site closer to customers' premises 105 than central station generation. The small-scale power resource 103 (in FIG. 1 distributed resource 103 is a distributed generator) may be interconnected to the distribution system, “the grid” (not shown) and/or may be connected directly to a customer's premise or facility 105. To control a distributed resource 103, distributed resource 103 is connected to a controller 107, such as a conventional programmable logic controller (PLC). Controller 107 may be connected to a communications device 109 such as a modem. A power station 190 comprises a distributed resource 103, a controller 107 and a communications device 190.

An electrical power station can include a single power generator, as illustrated in power station 190, or a plurality of power generators (not shown). An electric power station can include a single energy storage unit or a plurality of storage units (not shown). An electric power station (not shown) may include no power storage units. Power stations may be distributed over a geographical region or be located in one area.

Local Control

An embodiment of the invention controls dispatch of a distributed resource (DR) or resources in an electrical power system from one or more local controllers. Dispatching is based on a local decision made by an intelligent local device at each unit or group of units. The intelligent device associated with the distributed resource(s) is pre-programmed with dispatching scenarios developed by other applications. The other applications may include, but are not limited to, peak shaving dispatch, voltage profile dispatch, reliability dispatch, thermal dispatch, site load following dispatch, local area dispatch and or resource scheduling. The dispatching decisions or scenarios preferably may be based on any single application output or may be based on a plurality of the other applications outputs at the DR control module. The dispatching level or scenarios preferably may be changed or adjusted by re-programming the local intelligent devices through the communication infrastructure. Such re-programming may involve continuous communication between the central controller and the distributed resources devices or could be downloaded at a predetermined time from the central control or other computer device, host, or server. It should be noted that continuous communication of the local control with the distributed resources devices is not required.

Each distributed resource or group of resources preferably is associated with a local controller, an intelligent device that receives information, and based on the information, controls the distributed resource(s). In this embodiment of the invention, decisions are preferably made at the device level. Types of information received by the local controller include, but are not limited to, price of power at a particular time and the amount of current power consumption. The local controller preferably is programmable and has been programmed with scenarios for distributed resource operation. For example, the controller may be programmed so that when a specified threshold of power usage is reached, the distributed resource is to be operated at 50% capacity.

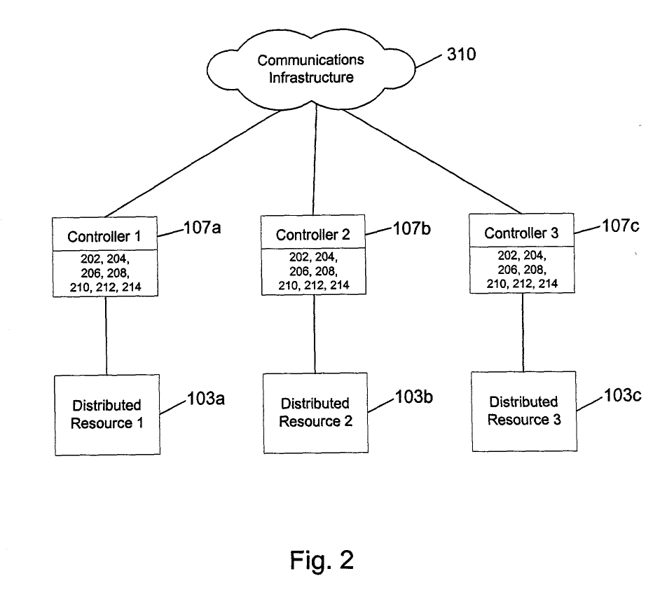

FIG. 2 illustrates an embodiment of a local control implementation of the invention. In FIG. 2, distributed resource 103a is connected to controller 107a, distributed resource 103b is connected to controller 107b and so on. Controllers 107a, 107b, etc. may be a conventional programmable logic controller (PLC). Controller 107a, 107b, etc. may be connected to a communications device (not shown) such as a modem, or may include such a communications device. Controllers 107a, 107b, etc. may communicate with communications infrastructure 310 via its associated communications device. Infrastructure 310 can be any suitable communications network, such as but not limited to, the World Wide Web or Internet. Alternatively, a communications link may be implemented via a hard-wired telephone line or by a wireless telephone system or by a combination thereof. Distributed resources 103a, 103b, etc. may be connected to a customer's premise (not shown) and/or to an electrical grid (not shown).

It should be understood that a customer's premise may represent entities including, but not limited to, factories or commercial establishments, whose power needs may be greater than the power needs of a typical residence. It should also be understood that a customer's premise may represent one or more customer premises whose aggregate needs may run into megawatts of power. Desirably, the premises are electrically connected either through a utility distribution grid or through a grid specifically installed for distributed power resources, or through any other suitable grid.

Distributed resources 103 include, but are not limited to, distributed generators such as gas turbines, photovoltaics, wind turbines, engine generators, fuel cells, and supplementary power received from the grid. Distributed generators include small-scale power generation units that produce a few kilowatts (kW) to 10 megawatts (MW) of power; however, the scope of the disclosed invention includes control and management of units producing power outside this range.

In addition to distributed generation, distributed resources include distributed storage units (not shown). Distributed storage units include, but are not limited to, batteries, super-conducting magnetic energy storage (SMES), and flywheels. Distributed storage units include small-scale power storage units that produce a few kilowatts to 10 MW of power and store that power from seconds to hours, for example. However, the disclosed invention includes within its scope, control and management of units producing and storing power outside this range.

Controllers 107a, 107b, etc. preferably are commonly known controllers that control the operation of distributed resources. Such controllers can be represented by conventional programmable logic controllers (PLCs). Preferably, controllers 107a, 107b, etc. include logic for applications including but not limited to: peak shaving dispatch 202, voltage profile dispatch 204, reliability dispatch 206, thermal dispatch 208, site load following dispatch 210, local area dispatch 212 and resource scheduling 214, described below.

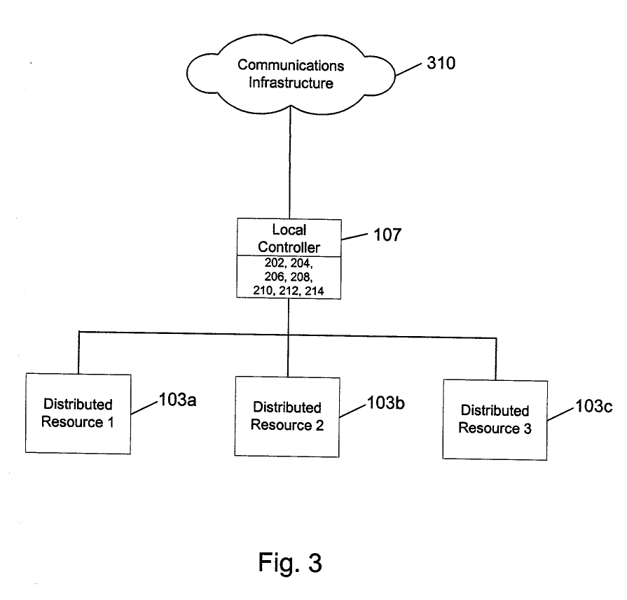

FIG. 3 illustrates an embodiment of the invention in which a single controller 107 is connected to a plurality of distributed resources, 103a, 103b, and so on to some maximum number of units determined by the limitations of controller 107. In this embodiment, the single controller 107 controls each of the plurality of distributed resources 103a, 103b, etc.

Central Control

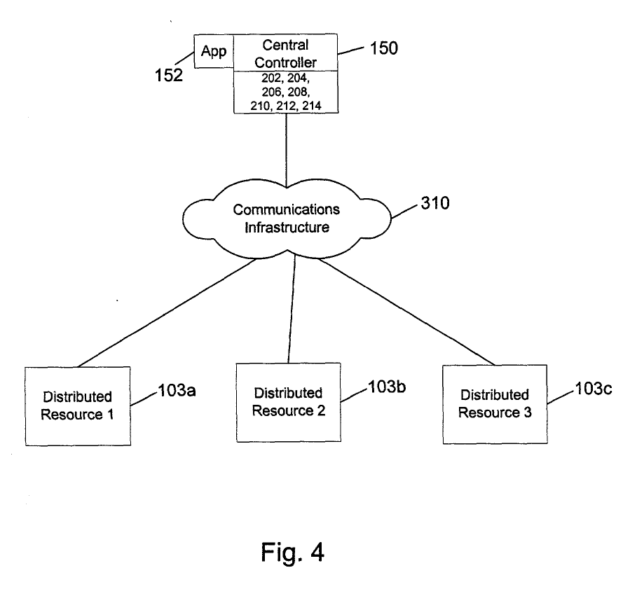

FIG. 4 illustrates an embodiment of the invention in which a central controller controls dispatch of distributed resources in an electrical power system. It should be understood that by “central” it is meant that the central controller operates as the controlling feature, and not that central controller is physically located in the center of the distributed resources. Dispatching in this embodiment is based on decisions made at the central controller 150. The central controller 150 controls multiple distributed resources based on various inputs and decision outcomes of applications 202-214 resident at the central controller.

In FIG. 4, central controller 150 preferably includes a central control application 152 and a communications device such as a modem (not shown). It should be noted that any appropriate device for transmission of data over a communications system may be used without departing from the spirit and scope of the invention and that, in addition, the communications device may be connected to, rather than included within, central controller 150.

Central controller 150 preferably is in communication with distributed resources 103a, 103b, etc. via a communications infrastructure 310. Communications infrastructure 310 may be a communications network such as the World Wide Web or Internet, or may comprise a dedicated communications link.

Central controller 150 may be any of a variety of computing devices well known in the art. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Central controller 150 preferably controls, manages and optimizes distributed resources including distributed resources 103a, 103b, etc. Central controller 150 receives information from distributed resources 103a, 103b, etc. via a communications device (not shown) associated with the distributed resource. Central controller 150 receives data concerning the operating state of distributed resources 103a, 103b, etc. Central controller 150 preferably also receives data concerning current power requirements of consumer premises 105. Central controller 150 also preferably receives information including but not limited to: configuration status, power prices, voltage and current ratios from sources available via communications infrastructure 310.

Decision outcomes based in part on the aforementioned information are generated by a plurality of applications 202-214 resident at the central controller 150. These applications preferably include but are not limited to: peak shaving dispatch, voltage profile dispatch, reliability dispatch, thermal dispatch, site load following dispatch, local area dispatch, and/or resource scheduling.

The dispatching decisions or scenarios preferably may be based on any single. application output, or may be based on the decision outcomes of a plurality of the applications at the DR control module. Based on the decision outcomes, central controller 150 operates power resources 103a, 103b, etc. to preferably maximize efficiency and minimize the cost of power production by operating the aggregated resources 103a, 103b, etc. according to results received from applications 202, 204, 206, etc. Central controller 150 controls and manages all distributed resources 103a, 103b, etc. so that the performance of all resources 103a, 103b, etc. is optimized. By optimization is meant, for example, to provide the highest quality of power output from resources 103a, 103b, etc., to minimize cost of power produced by resources 103a, 103b, etc., to maximize reliability of power, to maximize quality of power and/or to achieve some other objective or objectives.

The central control application 152 at the central controller 150 transmits one or more control signals to distributed devices 103a, 103b, etc. Control signals preferably include a desired dispatching level. The central controller 150 also preferably receives inputs from other parts of the system (e.g., other applications or modules) and sends these inputs to the distributed resources.

It should be noted that in this embodiment of the invention, because decisions are made by central controller 150, an intelligent device is not required at the local (device) level.

Desirably, the premises are electrically connected either through a utility distribution grid or through a grid specifically installed for distributed power resources, or through any other suitable grid. It should be understood that an enumerated quantity of distributed resources are denoted for exemplary purposes only. Any number of customer premises, distributed resources, controller and communications devices may be specified without departing from the spirit and scope of the invention.

The integration of different applications in a modular scheme preferably provides flexibility in updating or changing any of the features of the dispatch scheme, preferably enabling coordination, integration, and optimization of the use of a plurality of distributed resources assets.

Hybrid Control

An embodiment of the invention is directed to controlling dispatch of distributed resources in an electrical power system based on a combination of decisions made by a central controller and decisions made by one or more local controllers. In this embodiment, a hybrid scheme considers decisions made by a central control application and one or more decisions made by intelligent local devices at each unit or group of units.

As in the local control embodiments described herein, intelligent devices are associated with each distributed resource or group of resources, and are preferably pre-programmed with dispatching scenarios developed by the applications, including but not limited to, peak shaving dispatch, voltage profile dispatch, reliability dispatch, thermal dispatch, site load following dispatch, local area dispatch, and/or resource scheduling. Local dispatching decision outcomes may be based on an single application or may be based on a plurality of applications.

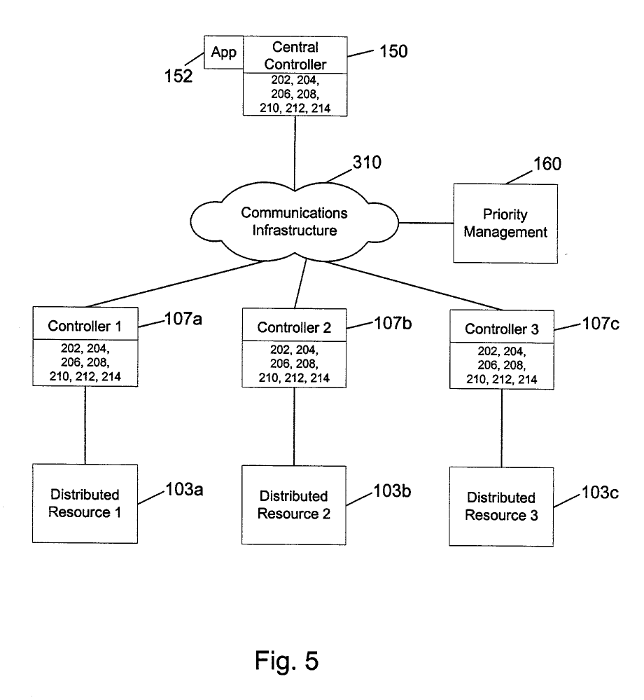

As in the central control embodiments described herein, decisions are also made at a central controller 150. Referring now to FIG. 5, decision outcomes from one or more local controllers 107a, 107b, etc. and decision outcomes from the central controller 150 are received by priority management component 160. A set of rules resident at priority management component 160 is preferably provided so that the priority of either control schemes may be determined.

When decisions are made both at the central and at the local level, a set of rules and constraints preferably determines the priority of the control schemes. That is, if the local control determines the distributed resource should be turned on and the central control determines the distributed resource should remain off, either the decision made at the local or control or the decision made at the central control will be acted upon based upon the previously determined priority or upon a set of priority rules.

In accordance with one aspect of the invention, a set of rules determines which controller takes precedence. The rules may specify that either the local controller takes precedence or that the central controller takes precedence. Alternatively, the rules may specify under what conditions the decisions of the central controller take precedence and under what conditions the decisions of the local controller take precedence.

When the central controller is given precedence (by the priority management component 160), the dispatching decisions/scenarios are transmitted as control signals from the central controller 150 to distributed devices 103a, 103b, etc. The control signals preferably include desired dispatching levels. When the local controller 107 is given precedence (by the priority management component), control signals from local controller 107 are received by distributed devices 103a, 103b, etc.

Control Applications

Preferably, the applications are customizable to adapt to the individual needs of customers. The applications may include software or computer-executable instructions.

Preferably, the peak shaving dispatch application dispatches the distributed resource or resources to utilize the electrical output of the distributed resource or resources to reduce the cost of electric power at the site. For example, the DR at a certain site may be set to turn on when the price of power is greater than 0.5 $/kWh. Consequently, a user may want to turn off certain non-critical operations when the price of power becomes 1.00 $/kWh.

The peak shaving dispatch application may be implemented in the local, central, or hybrid control embodiments and may be set to run upon user demand, periodically, or may be triggered by an event.

Input to the peak shaving dispatch application preferably includes any or all of the following: current site electrical supply level (in Watts, VArs, power factor), rate profile or real time price at site, threshold site cost level, application mode (Off/Manual/Auto), the application dispatch priority (1st, 2nd, etc.), and the present DR electrical output (in Voltage, Watts, VArs, Current, for example).

Outputs from the peak shaving dispatch application include the DR dispatch decision (yes or no), the DR dispatch level (in Voltage, Watts, VArs, Current), and the expected cost with and without the use of the DR and expected savings.

The voltage profile dispatch application preferably dispatches the DR to utilize the electrical output of the DR to maintain or improve a certain prescribed voltage level at the site. For example, if a certain site requires the voltage level of electrical power to be at 440 V, the voltage profile dispatch application may dispatch a DR device when the voltage deviates +/−5% at the site. Load shedding may be considered an alternative dispatch decision.

The peak shaving dispatch application may be implemented in the local, central, or hybrid control embodiments and may be set to run upon user demand, periodically, or may be triggered by an event.

Inputs to the voltage profile dispatch application preferably include the current site electrical supply level (in Voltage), threshold site percentage, application mode (Off/Manual/Auto), application dispatch priority (1st, 2nd, etc.), and present DR electrical output (in Voltage, Watts, VArs, Current).

Outputs from the voltage dispatch application preferably include the DR dispatch decision (yes or no), the DR dispatch level (in Voltage, Watts, VArs, Current), and the expected cost using the DR.

The reliability dispatch application dispatches the DR in order to utilize the electrical output of the DR to avoid interruption of electrical service. For example, if the load at a certain site is critical and cannot be interrupted under any circumstances, the reliability dispatch may be set to turn on the DR at this site when it is determined that the supply of power from the grid has been interrupted.

The peak shaving dispatch application may be implemented in the local, central, or hybrid control embodiments and may be set to run upon user demand, periodically, or may be triggered by an event.

Inputs to the reliability dispatch application preferably include current site electrical supply level (in Watts, VArs, power factor), threshold site load percentage (total load), application mode (Off/Manual/Auto), present DR electrical output (in Voltage, Watts, VArs, Current), cost of operating DR, cost of site outage, and application dispatch priority (1st, 2nd, etc.).

Outputs preferably include the expected cost with DR, the DR dispatch decision (Yes/No), and the DR dispatch level (in Voltage, Watts, VArs, Current).

The thermal dispatch application preferably dispatches the DR in order to utilize the heat/exhaust output of the DR; electric output of the DR in this scenario is a by-product. If, for example, a chemical process desirably maintains a temperature of 75° C., the thermal dispatch application may dispatch a DR device so that the exhaust from the DR device helps to maintain 75° C.

The peak shaving dispatch application may be implemented in the local, central, or hybrid control embodiments and may be set to run upon user demand, periodically, or may be triggered by an event.

Inputs to the thermal dispatch application include preferably the application dispatch priority (1st, 2nd, etc.), the present DR thermal output (Heat), the DR dispatch decision (Yes/No), the DR dispatch level (in Voltage, Watts, VArs, Current, Heat), and the expected cost of power using the DR.

The site load following dispatch application will dispatch the DR in order to utilize the electrical output of the DR to meet the demand (load) at the site. For example, this type of dispatch might be used at a village having no power network electrical connection, or to a power park that wishes to minimize the amount of power drawn from a power network. The DR at a certain site may be set to alter its electrical output to meet the demand at that site so that when the load at the site increases, the DR electrical output increases and when the load at a site decreases, the DR electrical output decreases.

The site load following dispatch application may be implemented in the local, central, or hybrid control embodiments and may be set to run upon user demand, periodically, or may be triggered by an event.

Inputs to the site load following dispatch application preferably include current site electrical supply level (in Watts, VArs, power factor), the forecasted load profile, the application mode (Off/Manual/Auto), the application dispatch priority (1st, 2nd, etc.), and the present DR electrical output (in Voltage, Watts, VArs, Current).

Outputs from the site load following dispatch application include the DR dispatch decision (Yes/No) and the DR dispatch level (in Voltage, Watts, VArs, Current), the expected cost with and without use of the DR, and expected savings.

The local area dispatch application dispatches the DR in order to utilize the electrical output of the DR to meet or exceed the demand (load) at multiple sites. This type of dispatch may be used, for example, at multiple industrial sites located close to each other that wish to maintain a certain total level of import from or export to a power network.

For example, the DR at multiple sites may be set to alter its electrical output to maintain a certain penetration level on the power network from that site. If the load increases at the site, the DR electrical output is increased and when the load decreases at a site, the DR electrical output is decreased.

The local area dispatch application may only be implemented in the central control or hybrid control embodiments and may be set to run upon user demand, periodically, or may be triggered by an event.

Inputs to the local area dispatch application may include cumulative site electrical supply level (in Watts, VArs, power factor), forecasted load profile, threshold site penetration level, application mode (Off/Manual/Auto), application dispatch priority (1st, 2nd, etc.), and present DR electrical output (in Voltage, Watts, VArs, Current).

Outputs from the local area dispatch application may include DR dispatch decision (Yes/No), DR dispatch level (in Voltage, Watts, VArs, Current), expected cost with and without DR and expected savings.

The resource scheduling application preferably enables an operator to schedule DR assets to be operated or dispatched at a certain level at a certain time. For example, a user may want his DR at a certain site to be operated every Tuesday afternoon from 3 PM to 6 PM at half capacity.

The resource scheduling application may be implemented in the local, central, or hybrid control embodiments and may be set to run upon user demand. Inputs preferably include previous DR output, forecasted DR profile, forecasted Load Profile, forecasted Rate Profile, and forecasted Cost Profile. Outputs preferably include dispatch decision (On/Off/Level) based on the entered profile.

Power stations may include, but are not limited to, any of the following distributed resources: cogeneration, providing both electricity and heat or cooling at the same time, wind turbines, microturbines, fuel cells, photovoltaic units, and supplementary energy from the national transmission grid. Many consumer premises at many locations may be served, as if in one centralized system.

More particularly, different power sources can be linked together in the power station system, including but not limited to the following: cogeneration which provides both electricity and heat or cooling at the same time; wind turbines which are becoming increasingly viable following dramatic reductions in cost and significant breakthroughs in performance and reliability; microturbines that are expected to offer low-cost, cleaner power in the 25-500 kW range within the next few years; fuel cells that are expected to provide clean, competitive power in the 2-300 kW range; photovoltaic technologies that are able to convert sunlight directly to electricity from 2-300 kW; and supplementary energy from the national transmission grid. The disclosed invention can link these distributed resources together and operate them independently (delivering the power directly to a community or user) or attach the microgrid to the conventional grid.

It should be understood that the scope of the invention is not limited to any particular number of electric resource units or amount of electric power produced or stored.

It should be understood that enabling technologies well known in the art such as inverters for DC (direct current) generation sources such as for example, fuel cells, interfaces for energy storage devices such as batteries and flywheels, static switchgear, microprocessor-based sensors and control, interfaces with higher level controls, on-board diagnostics and monitoring, automated utility interfaces for dispatching, low voltage transfer switches, and breakers, communication between resource system and end-user, remote dispatching, automated dispatching based on real time cost information, and remote, automated metering may be employed as needed.

A number of potential benefits for the end-users of the disclosed invention are possible. For example, the disclosed invention may lead to reduced energy and demand bills because instead of operating an existing power plant at an unoptimized and therefore inefficient level, distributed resources operating at higher efficiency rates could be employed. Additional advantages may include enhanced “energy management” and flexibility, and increased reliability (e.g., instead of relying on one distributed resource, a plurality of distributed resources could be used).

Illustrative Computing Environment

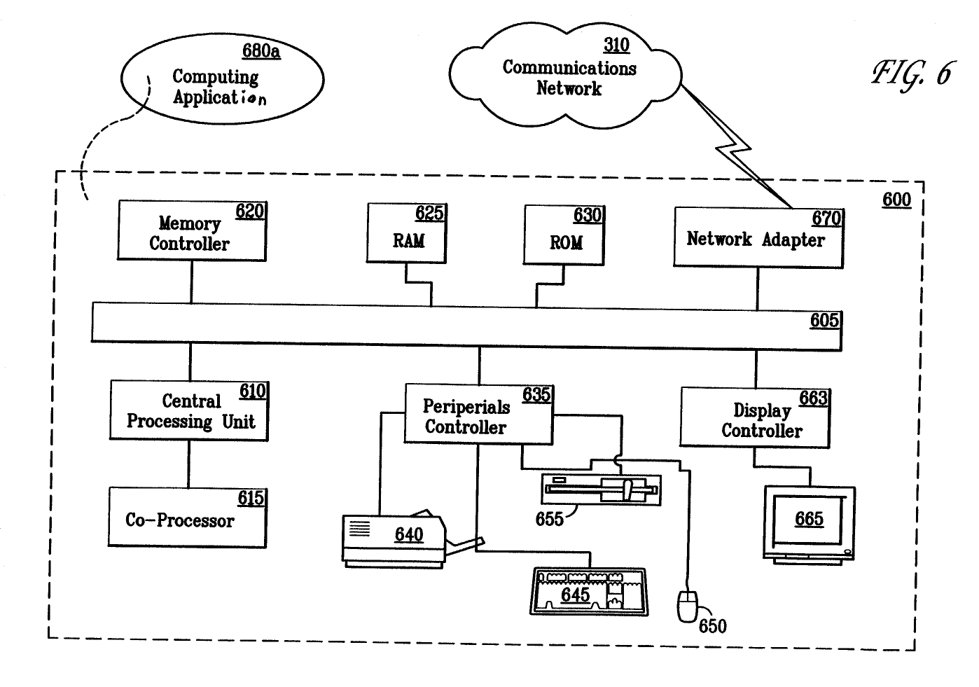

FIG. 6 depicts an exemplary computing system 600 in accordance with the invention. Computing system 600 executes an exemplary computing application 680a capable of controlling and managing a group of distributed resources so that the management of distributed resources is optimized in accordance with the invention. Exemplary computing system 600 is controlled primarily by computer-readable instructions, which may be in the form of software, wherever or by whatever means such software is stored or accessed. Such software may be executed within central processing unit (CPU) 610 to cause data processing system 600 to do work. In many known workstations and personal computers, central processing unit 610 is implemented by a single-chip CPU called a microprocessor. Co-processor 615 is an optional processor, distinct from main CPU 610, that performs additional functions or assists CPU 610. One common type of co-processor is the floating-point co-processor, also called a numeric or math co-processor, which is designed to perform numeric calculations faster and better than general-purpose CPU 610. Recently, however, the functions of many co-processors have been incorporated into more powerful single-chip microprocessors.

In operation, CPU 610 fetches, decodes, and executes instructions, and transfers information to and from other resources via the computer's main data-transfer path, system bus 605. Such a system bus connects the components in computing system 600 and defines the medium for data exchange. System bus 605 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 610. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 605 include random access memory (RAM) 625 and read only memory (ROM) 630. Such memories include circuitry that allows information to be stored and retrieved. ROMs 630 generally contain stored data that cannot be modified. Data stored in RAM 625 can be read or changed by CPU 610 or other hardware devices. Access to RAM 625 and/or ROM 630 may be controlled by memory controller 620. Memory controller 620 may provide an address translation finction that translates virtual addresses into physical addresses as instructions are executed. Memory controller 620 also may provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 600 may contain peripherals controller 635 responsible for communicating instructions from CPU 610 to peripherals, such as, printer 640, keyboard 645, mouse 650, and disk drive 655.

Display 665, which is controlled by display controller 663, is used to display visual output generated by computing system 600. Such visual output may include text, graphics, animated graphics, and video. Display 665 may be implemented with a CRT-based video display, an LCD-based flat-panel display, gas plasma-based flat-panel display, or a touch-panel. Display controller 663 includes electronic components required to generate a video signal that is sent to display 665.

Further, computing system 600 may contain network adaptor 670 which may be used to connect computing system 600 to an external communication network 310. Communications network 310 may provide computer users with means of communicating and transferring software and information electronically. Additionally, communications network 310 may provide distributed processing, which involves several computers and the sharing of workloads or cooperative efforts in performing a task. It will be appreciated that the network connections shown are exemplary and other means of establishing a communications link between the computers may be used.

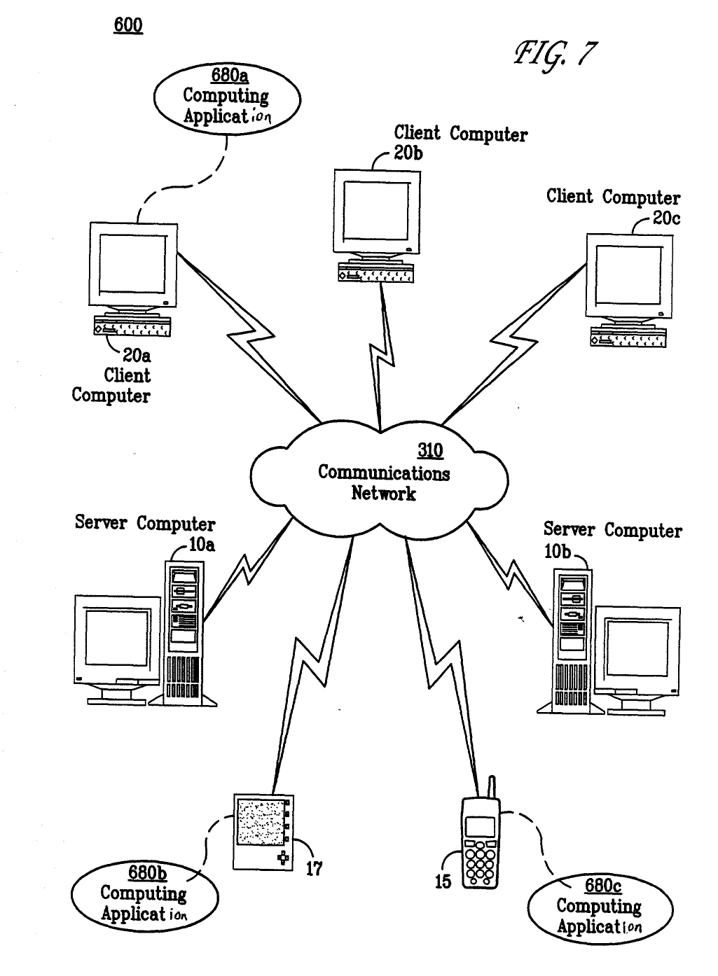

As noted above, the computer described with respect to FIG. 6 can be deployed as part of a computer network. In general, the above description applies to both server computers and client computers deployed in a network environment. FIG. 7 illustrates an exemplary network environment, with server computers 10a, 10b in communication with client computers 20a, 20b, 20c via a communications network 310, in which the present invention may be employed.

As shown in FIG. 7, a number of servers 10a, 10b, etc., are interconnected via a communications network 310 (which may be a LAN, WAN, intranet or the Internet) with a number of client computers 20a, 20b, 20c, or computing devices, such as, mobile phone 15 and personal digital assistant 17. In a network environment in which communications network 310 is the Internet, for example, servers 10 can be Web servers with which clients 20 communicate via any of a number of known protocols, such as, hypertext transfer protocol (HTTP) or wireless application protocol (WAP), as well as other innovative communication protocols. Each client computer 20 can be equipped with computing application 680a to gain access to servers 10. Similarly, personal digital assistant 17 can be equipped with computing application 680b and mobile phone 15 can be equipped with computing application 680c to display and receive various data.

Thus, the present invention can be utilized in a computer network environment having client computing devices for accessing and interacting with the network and a server computer for interacting with client computers. However, the systems and methods of the present invention can be implemented with a variety of network-based architectures, and thus should not be limited to the example shown.

Although illustrated and described herein with reference to certain specific embodiments, the present invention is nevertheless not intended to be limited to the details shown. Rather, various modifications may be made in the details within the scope and range of equivalents of the claims without departing from the invention.

What is claimed:

1. A control system for a power system, comprising:
a plurality of distributed resources that generate power;
a plurality of intelligent components, each intelligent component associated with one of the plurality of distributed resources to provide control to the distributed resource;
a central controller coupled to the distributed resources via a communications network to provide control to the distributed resources; and
a priority manager that determines a priority of control for the plurality of intelligent components and the central controller.

2. The control system of claim 1, wherein the priority manager comprises a set of rules to determine the priority of control of each distributed resource between the associated intelligent component and the central controller.

3. The control system of claim 1, wherein each intelligent component and the central controller comprises at least one dispatching scheme.

4. The control system of claim 3, wherein the dispatching scheme comprises an operating status of at least one distributed resource.

5. The control system of claim 3, wherein the dispatching scheme comprises a level of operational capacity of at least one distributed resource.

6. The control system of claim 3, wherein the dispatching scheme is adjustable responsive to predetermined criteria.

7. The control system of claim 1, wherein each distributed resource is controllable responsive to at least one dispatching scheme.

8. The control system of claim 7, wherein each dispatching scheme is responsive to at least one of a peak shaving application, a voltage profile dispatch application, a reliability dispatch application, a thermal dispatch application, a site load following dispatch application, a local area dispatch application, and a resource scheduling application.

9. The control system of claim 1, wherein each intelligent component monitors the status of the power system and controls the associated distributed resource responsive to the status of the power system.

10. The control system of claim 1, wherein the central controller and the intelligent components are connected to a power distribution grid via the communications network.

11. The control system of claim 1, wherein each distributed resource produces power in the range between about 2 kilowatts and about 10 megawatts.

12. The control system of claim 1, wherein the central controller monitors the status of the power system and the operating state of the distributed resources and controls the distributed resources responsive to the status of the power system and the operating state of the distributed resources.

13. The control system of claim 1, wherein the priority of control provides an order in which the central controller and at least one of the intelligent components provide control to the distributed resources.

14. The control system of claim 1, wherein each distributed resource is controlled by a plurality of orders issued by the central controller and at least one of the intelligent components.

15. The control system of claim 1, wherein when the central controller is given priority by the priority manager, an order is transmitted as a control signal from the central controller to the distributed resource, and when one of the intelligent components is given priority by the priority manager, an order is transmitted as a control signal from the intelligent component to the distributed resource.

16. A method of controlling a power system comprising:
providing a plurality of distributed resources that generate power;
providing a plurality of intelligent components, each intelligent component associated with one of the plurality of distributed resources to provide control to the distributed resource;
coupling a central controller to the distributed resources via a communications network to provide control to the distributed resources; and
determining a priority of control for the plurality of intelligent components and the central controller.

17. The method of claim 16, wherein determining the priority of control comprises generating a set of rules to determine the priority of control of each distributed resource between the associated intelligent component and the central controller.

18. The method of claim 16, further comprising providing each intelligent component and the central controller with at least one dispatching scheme.

19. The method of claim 18, wherein the dispatching scheme comprises an operating status of at least one distributed resource.

20. The method of claim 18, wherein the dispatching scheme comprises a level of operational capacity of at least one distributed resource.

21. The method of claim 18, further comprising adjusting the dispatching scheme responsive to predetermined criteria.

22. The method of claim 16, further comprising controlling each distributed resource responsive to at least one dispatching scheme.

23. The method of claim 22, wherein each dispatching scheme is responsive to at least one of a peak shaving application, a voltage profile dispatch application, a reliability dispatch application, a thermal dispatch application, a site load following dispatch application, a local area dispatch application, and a resource scheduling application.

24. The method of claim 16, further comprising monitoring the status of the power system and controlling the associated distributed resource responsive to the status of the power system.

25. The method of claim 16, further comprising connecting the central controller and the intelligent components to a power distribution grid via the communications network.

26. The method of claim 16, further comprising producing power in the range between about 2 kilowatts and about 10 megawatts at each distributed resource.

27. The method of claim 16, further comprising monitoring the status of the power system and the operating state of the distributed resources at the central controller and controlling the distributed resources responsive to the status of the power system and the operating state of the distributed resources.

28. The method of claim 16, wherein determining the priority of control comprises providing an order in which the central controller and at least one of the intelligent components provide control to the distributed resources.

29. The method of claim 16, further comprising controlling each distributed resource by a plurality of orders issued by the central controller and at least one of the intelligent components.

30. The method of claim 16, further comprising:
when the central controller is given priority by the priority manager, transmitting an order as a control signal from the central controller to the distributed resource; and
when one of the intelligent components is given priority by the priority manager, transmitting an order as a control signal from the intelligent component to the distributed resource.
